(19) United States
(12) Patent Application Publication
(10) Pub. No.: US 2022/0010094 A1
(43) Pub. Date: Jan. 13, 2022

(54) NANO-SILVER DISPERSION AND PREPARATION METHOD THEREOF

(71) Applicant: Qingdao University of Technology, Qingdao (CN)

(72) Inventors: Zuquan JIN, Qingdao (CN); Shaochun LI, Qingdao (CN); Yongjuan GENG, Qingdao (CN); Dongshuai HOU, Qingdao (CN); Anjie ZHOU, Qingdao (CN); Jun LIU, Qingdao (CN)

(21) Appl. No.: 17/369,129

(22) Filed: Jul. 7, 2021

(30) Foreign Application Priority Data
Jul. 9, 2020 (CN) 202010655687.8

(51) Int. Cl. C08K 3/28; C08K 5/5419; C08K 5/41; C08K 3/38; C04B 26/04

(52) U.S. Cl. CPC C08K 3/28; C08K 5/5419; C08L 39/06; C08K 3/38; C04B 26/04; C08K 5/41

(57) ABSTRACT

A nano-silver dispersion and a preparation method thereof is disclosed. The method, includes: mixing γ-aminopropyltriethoxysilane, polyvinylpyrrolidone, sodium lauryl sulfate, silver nitrate and water, and conducting a chelation, to obtain a chelating dispersion, wherein before the mixing, the γ-aminopropyltriethoxysilane is exposed to the air for less than 5 min; and dropwise adding a sodium borohydride solution into the chelating dispersion, to obtain a mixture, and subjecting the mixture to an oxidation-reduction reaction, to obtain the nano-silver dispersion.

### CROSS REFERENCE TO RELATED APPLICATION

The present application claims the benefit and priority of Chinese Patent Application No. 202010655687.8 filed on Jul. 9, 2020, the disclosure of which is incorporated by reference herein in its entirety as part of the present application.

### TECHNICAL FIELD

The present disclosure relates to the technical field of the preparation of nano-silver, and in particular to a nano-silver dispersion and a preparation method thereof.

### BACKGROUND ART

Concrete is often attached by microorganisms during service, which would cause marine organism fouling, reducing the service life of the concrete. The corrosion of concrete caused by marine microorganisms has caused immeasurable losses to concrete buildings such as sea-crossing bridges.

In order to reduce the impact of marine microorganisms on concrete, nano-silver dispersion is usually added in the process of mixing concrete, thereby ensuring the normal service environment of the concrete and avoiding the corrosion of the concrete by iron bacteria and sulfur-oxidizing bacteria. However, the nano-silver in nano-silver dispersions currently prepared has a relatively large particle size (generally 50 nm), being prone to agglomeration, which directly affects the antibacterial performance of the nano-silver dispersions.

### SUMMARY

An object of the present disclosure is to provide a nano-silver dispersion and a preparation method thereof. The nano-silver in the nano-silver dispersion prepared by the method of the present disclosure has a small particle size and good dispersibility.

In order to achieve the above object, the present disclosure provides the following technical solutions:

The present disclosure provides a method for preparing a nano-silver dispersion, comprising:

mixing γ-aminopropyltriethoxysilane, polyvinylpyrrolidone, sodium lauryl sulfate, silver nitrate and water, and conducting a chelation, to obtain a chelating dispersion, wherein before the mixing, the γ-aminopropyltriethoxysilane is exposed to the air for less than 5 min; and

dropwise adding a sodium borohydride solution into the chelating dispersion, to obtain a mixture, and subjecting the mixture to an oxidation-reduction reaction, to obtain the nano-silver dispersion.

In some embodiments, the mixing is performed as follows: mixing γ-aminopropyltriethoxysilane, silver nitrate and water, conducting a chelation, and then adding polyvinylpyrrolidone and sodium lauryl sulfate thereto.

In some embodiments, the dropwise adding is performed by continuously dropwise adding or interval dropwise adding.

In some embodiments, the interval dropwise adding is performed at a time interval of 3-8 seconds.

In some embodiments, a mass ratio of γ-aminopropyltriethoxysilane to silver nitrate is in the range of (2.2-2.8):1.

In some embodiments, a mass ratio of polyvinylpyrrolidone to silver nitrate is in the range of (2.5-3.5):1.

In some embodiments, a mass ratio of sodium lauryl sulfate to silver nitrate is in the range of (2.5-3.5):1.

In some embodiments, a mass ratio of sodium borohydride in the sodium borohydride solution to silver nitrate is in the range of (0.05-0.08):1.

In some embodiments, a mass fraction of the sodium borohydride solution is in the range of 0.05-0.07%.

The present disclosure provides a nano-silver dispersion prepared by the method as described in the above technical solutions, which contains nano-silver, and the nano-silver has a particle size of not more than 25 nm.

The present disclosure provides a method for preparing a nano-silver dispersion, comprising: mixing γ-aminopropyltriethoxysilane, polyvinylpyrrolidone, sodium lauryl sulfate, silver nitrate and water, and conducting a chelation, to obtain a chelating dispersion, wherein before the mixing, the γ-aminopropyltriethoxysilane is exposed to the air for less than 5 min; and dropwise adding a sodium borohydride solution into the chelating dispersion, to obtain a mixture, and subjecting the mixture to an oxidation-reduction reaction, to obtain the nano-silver dispersion.

In the present disclosure, γ-aminopropyltriethoxysilane (KH-550) is used as a chelating agent, and both of polyvinylpyrrolidone (PVP) and sodium lauryl sulfate are used as dispersants. The chelation of the amino group of KH-550 and silver ions and the dispersion effect of dispersants enables the silver ions to be sufficiently disperse during the oxidation process, which makes the particle size of nano-silver small enough. After the nano-silver is generated, the dispersants make the nano-silver disperse in water phase, resulting in adherence of KH-550 onto the surface of the nano-silver by hydroxyl condensation. The amino group of KH-550 is a hydrophilic group, and it could stabilize the nano-silver in the water phase by hydrogen bonding. Therefore, the nano-silver dispersion prepared by the present disclosure has a good dispersion effect, and could be stored for a relatively long time.

Furthermore, γ-aminopropyltriethoxysilane could modify the surface of nano-silver. Aminated nano-silver has a positive charge, and could bind to the bacterium with a negatively charge on the surface thereof through an electrostatic attraction, which significantly improves the antibacterial activity.

Because γ-aminopropyltriethoxysilane is very easy to absorb water and condense in the air, it could affect the preparation of the nano-silver dispersion by affecting the composition of γ-aminopropyltriethoxysilane, resulting in agglomeration of the final prepared nano-silver. Therefore, in the present disclosure, before the mixing, γ-aminopropyltriethoxysilane should be exposed to air for less than 5 min.

The method of the present disclosure is performed at normal temperature, being simple for operation.

The results of the examples show that the nano-silver in the nano-silver dispersion prepared by the method of the present disclosure has a particle size of not more than 25 nm, most of which are below 10 nm.

### BRIEF DESCRIPTION OF THE DRAWINGS

FIG. 1a and FIG. 1b show a transmission electron micrograph images of the nano-silver dispersion prepared in Example 1.

FIG. 2a and FIG. 2b show a transmission electron micrograph images of the nano-silver dispersion prepared in Example 2.

FIG. 3a and FIG. 3b show a transmission electron micrograph images of the nano-silver dispersion prepared in Example 3.

FIG. 4 shows a transmission electron micrograph image of the nano-silver dispersion prepared in Comparative Example 1.

FIG. 5a and FIG. 5b show a transmission electron micrograph images of the nano-silver dispersion prepared in Comparative Example 2.

### DETAILED DESCRIPTION OF THE EMBODIMENTS

The present disclosure provides a method for preparing a nano-silver dispersion, comprising:

mixing γ-aminopropyltriethoxysilane, polyvinylpyrrolidone, sodium lauryl sulfate, silver nitrate and water, and conducting a chelation, to obtain a chelating dispersion, wherein before the mixing, the γ-aminopropyltriethoxysilane is exposed to the air for less than 5 min; and

dropwise adding a sodium borohydride solution into the chelating dispersion, to obtain a mixture, and subjecting the mixture to an oxidation-reduction reaction, to obtain the nano-silver dispersion.

In the present disclosure, unless otherwise specified, the raw materials used are all commercially available products well known in the art.

In the present disclosure, γ-aminopropyltriethoxysilane, polyvinylpyrrolidone, sodium lauryl sulfate, silver nitrate and water are mixed, and the resulting mixture is subjected to a chelation, to obtain a chelating dispersion.

According to the present disclosure, in some embodiments, after the mixing, the resulting mixture is stirred for 15-30 seconds at a rotational speed of 2000 r/s.

According to the present disclosure, in some embodiments, the mixing is performed as follows: mixing γ-aminopropyltriethoxysilane, silver nitrate and water, conducting a chelation, and then adding polyvinylpyrrolidone and sodium lauryl sulfate thereto.

According to the present disclosure, in some embodiments, under the condition that γ-aminopropyltriethoxysilane, silver nitrate and water are first mixed, the resulting mixture is subjected to a chelation, and polyvinylpyrrolidone and sodium lauryl sulfate are then added thereto, after γ-aminopropyltriethoxysilane, silver nitrate and water are mixed, the resulting mixture is stirred for 15-30 s, during which silver nitrate and γ-aminopropyltriethoxysilane undergo a chelation, and specifically amino group of γ-aminopropyltriethoxysilane and silver ions undergo a chelation. According to the present disclosure, in some embodiments, after polyvinylpyrrolidone and sodium lauryl sulfate are added thereto, the resulting mixture is then stirred for another 15-30 s at a rotational speed of 2000 r/s.

In the present disclosure, nano-silver in the nano-silver dispersion prepared by mixing γ-aminopropyltriethoxysilane, silver nitrate and water first, and then adding polyvinylpyrrolidone and sodium lauryl sulfate thereto, has a smaller of particle size, and more uniform dispersion compared with that prepared by the method of directly mixing γ-aminopropyltriethoxysilane, polyvinylpyrrolidone, sodium lauryl sulfate, silver nitrate and water. This is due to the fact that when γ-aminopropyltriethoxysilane, silver nitrate and water are mixed first, a chelation will take place, which prevents the silver ions from being too dense.

According to the present disclosure, in some embodiments, a mass ratio of γ-aminopropyltriethoxysilane to silver nitrate is in the range of (2.2-2.8):1, and more preferably 2.6:1; a mass ratio of polyvinylpyrrolidone to silver nitrate is in the range of (2.5-3.5):1, and more preferably 3.0:1; a mass ratio of sodium lauryl sulfate to silver nitrate is in the range of (2.5-3.5):1, and more preferably 3.0:1. In the present disclosure, there are no special restrictions for the amount of water, as long as the raw materials could be mixed to be uniform. Those skilled in the art could adjust the amount of water according to the final concentration of nano-silver in the nano-silver dispersion, and the adjustment amount is calculated by converting all silver nitrate into nano-silver. According to the present disclosure, in some embodiments, the water is distilled water.

In the present disclosure, before the mixing, the γ-aminopropyltriethoxysilane is exposed to the air for less than 5 min, and in some embodiments, it is taken as needed. Because γ-aminopropyltriethoxysilane is very easy to absorb water and condense in the air, which affects the preparation of the nano-silver dispersion by affecting the composition of γ-aminopropyltriethoxysilane, resulting in agglomeration of the final prepared nano-silver. Therefore, before the mixing, γ-aminopropyltriethoxysilane should be exposed to the air for less than 5 min.

In the present disclosure, after obtaining the chelating dispersion, the sodium borohydride solution is dropwise added into the chelating dispersion to undergo an oxidation-reduction reaction to obtain a nano-silver dispersion. According to the present disclosure, in some embodiments, the solvent in the sodium borohydride solution is water, and a mass fraction of sodium borohydride in the sodium borohydride solution is in the range of 0.05-0.07%, and more preferably 0.06%. According to the present disclosure, in some embodiments, a mass ratio of sodium borohydride in the sodium borohydride solution to silver nitrate is in the range of (0.05-0.08):1, and more preferably (0.06-0.07):1.

According to the present disclosure, in some embodiments, the dropwise adding is conducted by continuously dropwise adding or interval dropwise adding, and more preferably interval dropwise adding. Under the condition that the interval dropwise adding is adopted, the interval dropwise adding is performed at a time interval of 5-8 s (that is, one drop is added every 5-8 s), and more preferably every 5 s. The nano-silver in the nano-silver dispersion prepared by the interval dropwise adding has more uniform and finer of particle size compared with that of nano-silver in the nano-silver dispersion prepared by continuously dropwise adding. This is because in the reaction process, the reducing agent of the interval dropwise adding could make the formation of nano-silver step by step, while reducing the concentration of local nano-silver and reducing the occurrence of agglomeration.

According to the present disclosure, in some embodiments, the dropwise adding is conducted by a stirring, and the stirring is conducted at a rotational speed of 2000 r/s.

In the present disclosure, during the process of dropwise adding sodium borohydride solution, sodium borohydride and silver ion are subjected to an oxidation-reduction reaction to obtain nano-silver. In the present disclosure, KH-550 is attached onto the surface of nano-silver by hydroxyl condensation, and the resulting product is dispersed in a solution to obtain a nano-silver dispersion.

The present disclosure provides a nano-silver dispersion prepared by the method as described in the above technical solution. The nano-silver in the nano-silver dispersion has a particle size of not more than 25 nm, preferably not more than 10 nm. The nano-silver dispersion has good dispersibility and antibacterial properties. In the present disclosure, there are no special restrictions for the concentration of the nano-silver dispersion, and the concentration could be adjusted according to actual needs.

The nano-silver dispersion and the preparation method thereof provided by the present disclosure will be described in detail below with reference with examples. It should not be understood as limiting the protection scope of the present disclosure.

The raw materials used in the following examples and comparative examples are as follows:

Silver nitrate was purchased from Shanghai Aibi Chemical Reagent Co., Ltd., China; sodium lauryl sulfate was purchased from Shanghai Aibi Chemical Reagent Co., Ltd., China; polyvinylpyrrolidone was purchased from Tianjin Dali Chemical Reagent Factory, China; sodium borohydride was purchased from Chengdu Chron Chemicals Co., Ltd., China; and γ-aminopropyltriethoxysilane was purchased from Jiangsu Chenguang Co., Ltd., China.

### EXAMPLE 1

0.3 g of polyvinylpyrrolidone (PVP), 0.3 g of sodium lauryl sulfate, 0.1 g of silver nitrate and 0.26 g of γ-aminopropyltriethoxysilane (KH-550, which was taken as needed) were added into 89.034 g of distilled water, and stirred at room temperature for 30 s with a magnetic stirrer at a rotational speed of 2000 r/s for a chelation, obtaining a chelating dispersion.

0.006 g of sodium borohydride was added into 10 g of distilled water, and stirred for dissolving, obtaining a sodium borohydride solution.

The sodium borohydride solution was continuously dropwise added (1 drop per second) into the chelating dispersion while stirring (with a rotational speed of 2000 r/s). After the dropwise addition was completed, a nano-silver dispersion (black-brown without precipitation) was obtained, wherein the mass fraction of the nano-silver was 0.06%.

### EXAMPLE 2

This example is conducted as described in Example 1, except that the sodium borohydride solution was dropwise added into the chelating dispersion at a time interval of every 5 s. After the dropwise addition was completed, a nano-silver dispersion (black-brown without precipitation) was obtained, wherein the mass fraction of the nano-silver was 0.06%.

### EXAMPLE 3

0.1 g of silver nitrate and 0.26 g of γ-aminopropyltriethoxysilane (KH-550) were added into 89.034 g of distilled water, and stirred at room temperature for 15 s with a magnetic stirrer at a rotational speed of 2000 r/s, 0.3 g of PVP and 0.3 g of sodium lauryl sulfate were then added thereto, and continuously stirred for 15 s, obtaining a chelating dispersion.

0.006 g of sodium borohydride was added into 10 g of distilled water, and stirred to be dissolved, obtaining a sodium borohydride solution.

The sodium borohydride solution was continuously dropwise added into the chelating dispersion while stirring (with a rotational speed of 2000 r/s). After the dropwise addition was completed, a nano-silver dispersion (black-brown without precipitation) was obtained, wherein the mass fraction of the nano-silver was 0.06%.

### COMPARATIVE EXAMPLE 1

0.3 g of PVP, 0.3 g of sodium lauryl sulfate, 0.1 g of silver nitrate, and 0.26 g of γ-aminopropyltriethoxysilane (KH-550) which had been left stood in the air for half an hour, were added into 89.034 g of distilled water, and stirred at room temperature for 30 s with a magnetic stirrer at a rotational speed of 2000 r/s, obtaining a chelating dispersion.

0.006 g of sodium borohydride was added into 10 g of distilled water, and stirred to be dissolved, obtaining a sodium borohydride solution.

The sodium borohydride solution was continuously dropwise added into the chelating dispersion while stirring (with a rotational speed of 2000 r/s). After the dropwise addition was completed, a nano-silver dispersion (yellow without precipitation) was obtained.

### COMPARATIVE EXAMPLE 2

0.1 g of silver nitrate and 0.26 g of γ-aminopropyltriethoxysilane (KH-550) were added into 89.634 g of distilled water, and stirred at room temperature for 30 s with a magnetic stirrer at a rotational speed of 2000 r/s, obtaining a chelating dispersion;

0.006 g of sodium borohydride was added into 10 g of distilled water, and stirred for dissolving, obtaining a sodium borohydride solution; and

The sodium borohydride solution was continuously dropwise added into the chelating dispersion while stirring (with a rotational speed of 2000 r/s). After the dropwise addition was completed, a nano-silver dispersion (with black precipitate) was obtained.

Structure and Performance Characterization

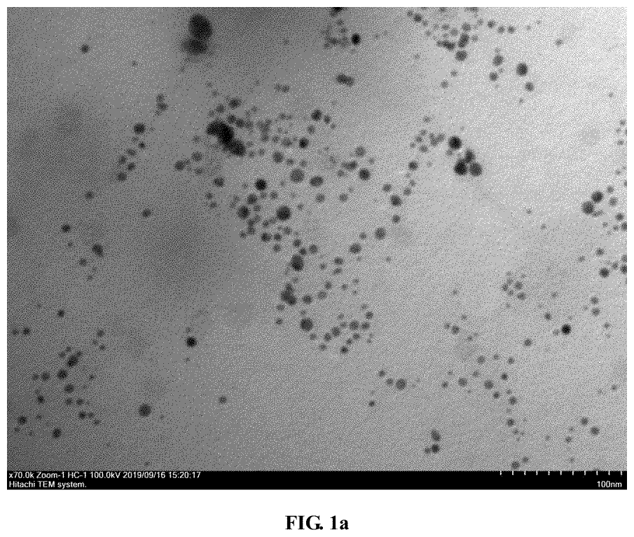

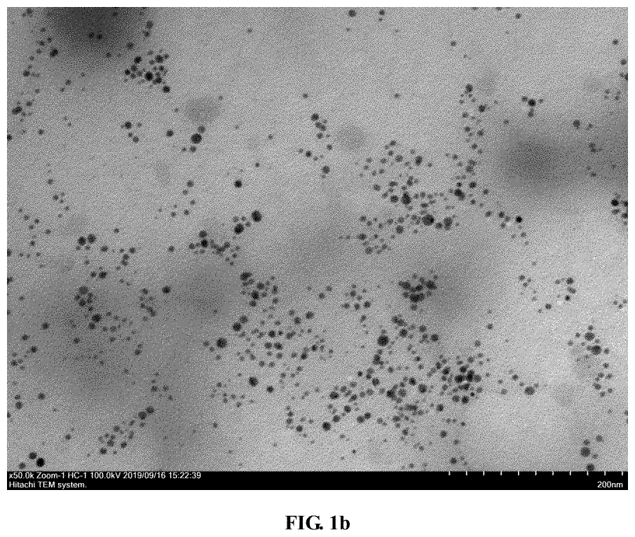

1. The nano-silver dispersions prepared in Examples 1 to 3 and Comparative Examples 1-2 were observed by transmission electron microscope, and the results were shown in FIGS. 1-5, respectively. In FIGS. 1-5, (a) and (b) are respectively transmission electron micrograph images of different parts of the nano-silver dispersion in the same example or in the same comparative example.

It can be seen from FIG. 1a and FIG. 1b that the nano-silver in the nano-silver dispersion prepared in Example 1 is spherical, with a particle size of not more than 25 nm, and most of which are about 10 nm.

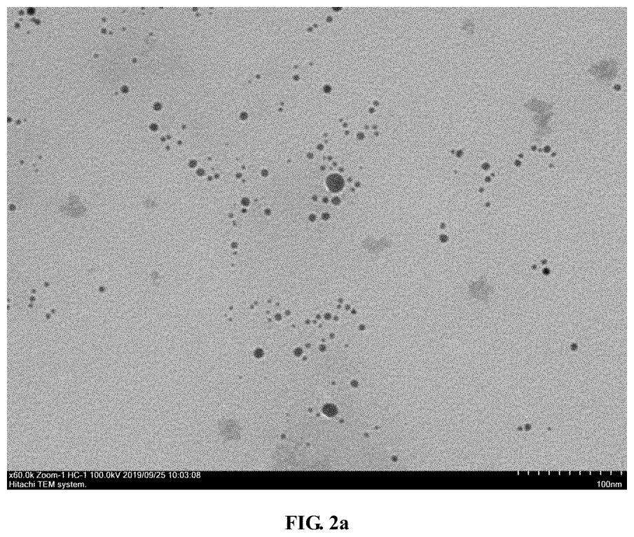

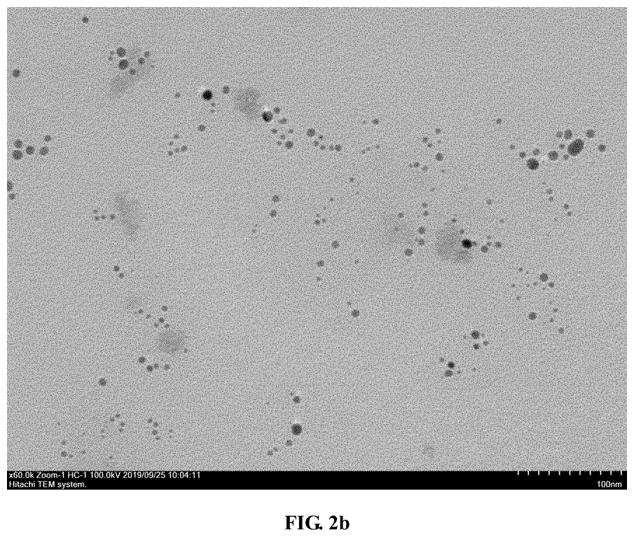

It can be seen from FIG. 2a and FIG. 2b that the nano-silver prepared by interval dropwise adding in Example 2 has significantly more uniform and smaller particle size than that in Example 1. There are various particle sizes but all tend to 10 nm.

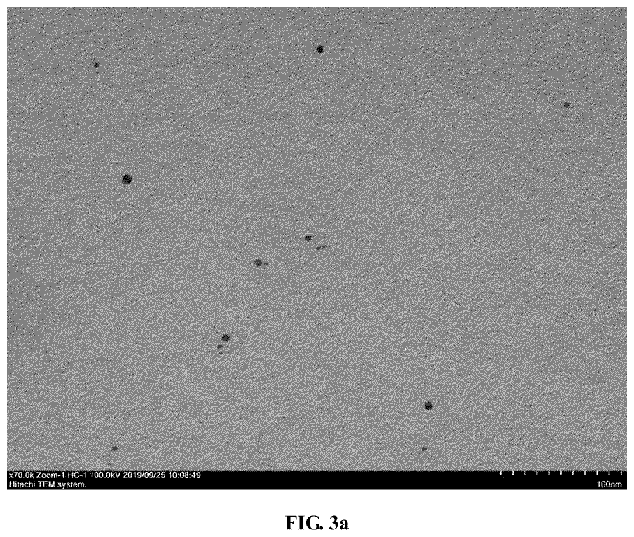

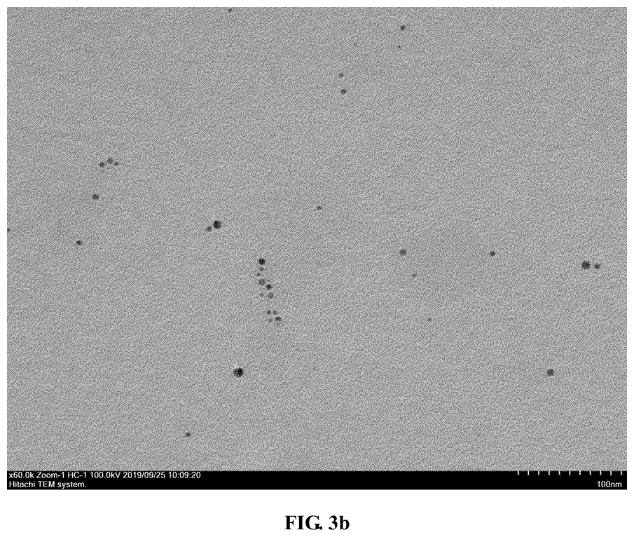

It can be seen from FIG. 3a and FIG. 3b that in Example 3, γ-aminopropyltriethoxysilane, silver nitrate and water were mixed, and subjected to a chelation, and polyvinylpyrrolidone and sodium lauryl sulfate were then added thereto for dispersion. The nano-silver particles prepared are small in size, most of which has a particle size of about lOnm, having the best effect.

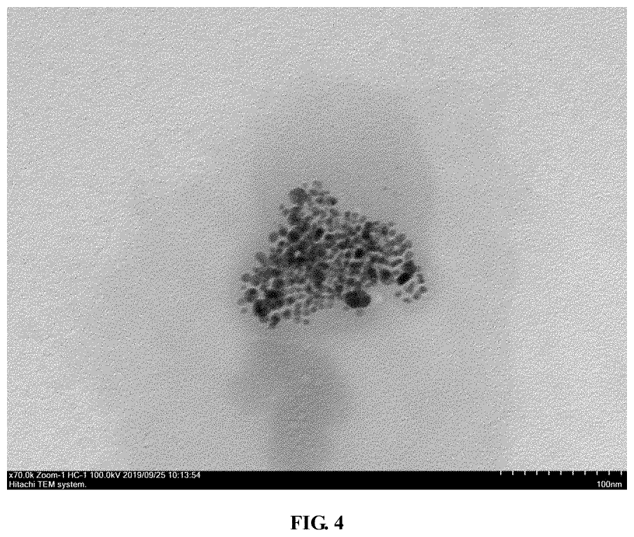

It can be seen from FIG. 4 that in Comparative Example 1, the nano-silver in the nano-silver dispersion prepared by γ-aminopropyltriethoxysilane after left standing for half an hour undergoes agglomeration, and it was formed by the agglomeration of about 10 nm spherical nano-silver, with regular morphology. This is because the γ-aminopropyltriethoxysilane after lefting stand for half an hour absorbs the moisture in the air and condenses, forming a cluster of substances, which may adsorb nano-silver particles, thereby forming a regular agglomerated nano-silver morphology.

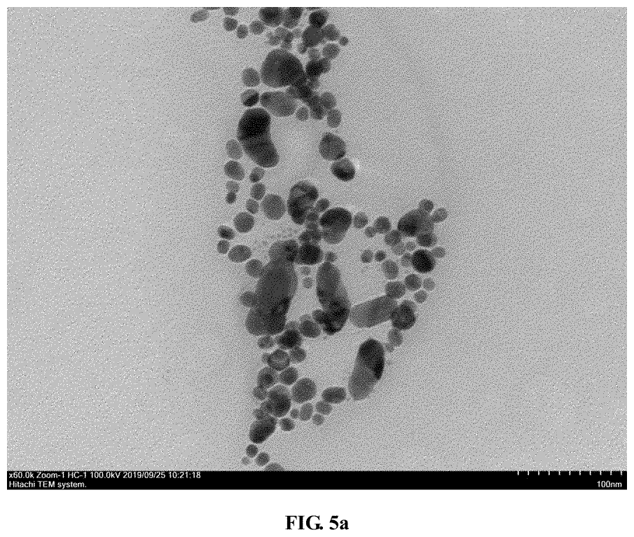

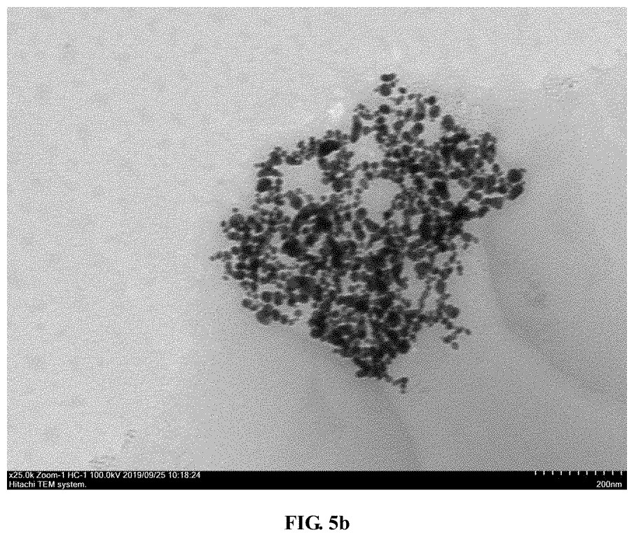

As can be seen from FIG. 5a and FIG. 5b that the nano-silver prepared without adding dispersants (PVP and sodium lauryl sulfate) in Comparative Example 2 is directly agglomerated together, and the particle size of a single nano-silver greatly increased to about 50 nm.

2. The nano-silver dispersion prepared in Example 1 was analyzed by UV-Vis spectroscopy, and the results are shown in Table 1.

TABLE 1
UV-Vis spectroscopy analysis results of
the dispersion prepared in Example 1

| No. | Wavelength (nm) | Absorbance (Abs) | Transmittance (%) |
|---|---|---|---|
| 1 | 451.0 | 2.804 | 0.2 |
| 2 | 433.0 | 2.720 | 0.2 |
| 3 | 424.0 | 1.779 | 1.7 |
| 4 | 362.0 | 2.717 | 0.2 |
| 5 | 354.0 | 2.575 | 0.2 |
| 6 | 434.0 | 2.719 | 0.2 |
| 7 | 427.0 | 1.770 | 1.7 |
| 8 | 372.0 | 1.434 | 3.7 |
| 9 | 355.0 | 2.670 | 0.2 |

The wavelengths in Table 1 are the different absorption peaks corresponding to the samples in Example 1, and the absorbance and transmittance are the absorbance and transmittance under each absorption peak.

It can be seen from the results in Table 1 that each absorption wavelength is the wavelength of nano-silver, which proves that the dispersion prepared by the present disclosure is indeed a dispersion of nano-silver. The changes in wavelength may be related to the red shift and blue shift caused by the size of the particle.

The nano-silver dispersions prepared in Examples 2-3 were subjected a UV-Vis spectroscopy, and the results are similar to those in Example 1, and all the results show that the dispersions prepared in Examples 2-3 are nano-silver dispersions.

3. The nano-silver dispersions prepared in Examples 1-3 are allowed to left stand in the air, and there are no precipitation after 1 month, indicating that the nano-silver dispersions prepared in Examples 1-3 could exist stably in the air for 1 month. Moreover, the dispersion diluted about 100 times with distilled water could exist stably for 1 year, indicating that the nano-silver dispersion prepared by the present disclosure has good stability and could be stored for a long time.

It can be seen from the above examples and comparative examples that the present disclosure provides a nano-silver dispersion and a preparation method thereof. The nano-silver in the nano-silver dispersion prepared by the method of the disclosure has a small particle size and good dispersibility.

The above are only the preferred embodiments of the present disclosure. It should be understood that for those of ordinary skill in the art, several improvements and modifications could be made without departing from the principle of the present disclosure, and those improvements and modifications also should be regarded as the protection scope of the present disclosure.

We claim:

1. A method for preparing a nano-silver dispersion, comprising:
mixing γ-aminopropyltriethoxysilane, polyvinylpyrrolidone, sodium lauryl sulfate, silver nitrate and water, and conducting a chelation, to obtain a chelating dispersion, wherein before the mixing, the γ-aminopropyltriethoxysilane is exposed to the air for less than 5 min; and,
dropwise adding a sodium borohydride solution into the chelating dispersion, to obtain a mixture, and subjecting the mixture to an oxidation-reduction reaction, to obtain the nano-silver dispersion.

2. The method of claim 1, wherein the mixing is performed as follows: mixing γ-aminopropyltriethoxysilane, silver nitrate and water, and conducting a chelation, and adding polyvinylpyrrolidone and sodium lauryl sulfate thereto.

3. The method of claim 1, wherein the dropwise adding is performed by continuously dropwise adding or interval dropwise adding.

4. The method of claim 3, wherein the interval dropwise adding is performed at a time interval of 3-8 seconds.

5. The method of claim 1, wherein a mass ratio of γ-aminopropyltriethoxysilane to silver nitrate is in the range of (2.2-2.8):1.

6. The method of claim 1, wherein a mass ratio of polyvinylpyrrolidone to silver nitrate is in the range of (2.5-3.5):1.

7. The method of claim 1, wherein a mass ratio of sodium lauryl sulfate to silver nitrate is in the range of (2.5-3.5):1.

8. The method of claim 1, wherein a mass ratio of sodium borohydride in the sodium borohydride solution to silver nitrate is in the range of (0.05-0.08):1.

9. The method of claim 8, wherein a mass fraction of the sodium borohydride solution is in the range of 0.05-0.07%.

10. A nano-silver dispersion prepared by the method of claim 1, comprising a nano-silver, and the nano-silver has a particle size of not more than 25 nm.

11. The method of claim 2, wherein a mass ratio of γ-aminopropyltriethoxysilane to silver nitrate is in the range of (2.2-2.8):1.

12. The method of claim 3, wherein a mass ratio of γ-aminopropyltriethoxysilane to silver nitrate is in the range of (2.2-2.8):1.

13. The method of claim 4, wherein a mass ratio of γ-aminopropyltriethoxysilane to silver nitrate is in the range of (2.2-2.8):1.

14. The method of claim 2, wherein a mass ratio of polyvinylpyrrolidone to silver nitrate is in the range of (2.5-3.5):1.

15. The method of claim 3, wherein a mass ratio of polyvinylpyrrolidone to silver nitrate is in the range of (2.5-3.5):1.

16. The method of claim 4, wherein a mass ratio of polyvinylpyrrolidone to silver nitrate is in the range of (2.5-3.5):1.

17. The method of claim 2, wherein a mass ratio of sodium lauryl sulfate to silver nitrate is in the range of (2.5-3.5):1.

18. The method of claim 3, wherein a mass ratio of sodium lauryl sulfate to silver nitrate is in the range of (2.5-3.5):1.

19. The method of claim 4, wherein a mass ratio of sodium lauryl sulfate to silver nitrate is in the range of (2.5-3.5):1.

20. The method of claim 2, wherein a mass ratio of sodium borohydride in the sodium borohydride solution to silver nitrate is in the range of (0.05-0.08):1.
